(19) United States
(12) Patent Application Publication
(10) Pub. No.: US 2003/0057353 A1
(43) Pub. Date: Mar. 27, 2003

(54) Wavefront coding zoom lens imaging systems

(76) Inventors: Edward Raymond Dowski JR., Lafayette, CO (US); Inga Prischepa, Boulder, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 09/910,675

(22) Filed: Jul. 20, 2001

(51) Int. Cl. G01J 1/20

(52) U.S. Cl. 250/201.9

(57) ABSTRACT

A simple and inexpensive wide-angle zoom lens with as few as two plastic elements codes the wavefront that is produced by the imaging system such that the imaging system is invariant to aberrations that are related to misfocus. Signal processing is then used to decode the wavefront to form the final image. A first type of zoom lens configuration uses as few as two lens elements. In these configurations, the image processing is modified to take into account the changing point spread function (PSF) of the system. A second type of zoom lens configuration that uses more than two lenses requires no modification of the processing.

### CROSS-REFERENCE TO RELATED APPLICATIONS

U.S. Pat. No. 5,748,371, issued May 5, 1998 and entitled “Extended Depth of Field Optical Systems,” is incorporated herein by reference. Pending U.S. application Ser. No. 09/875,435, filed Jun. 6, 2001, Ser. No. 09/875,766, filed Jun. 6, 2001, and Ser. No. 09/766,325, filed Jan. 19, 2001 are incorporated herein by reference.

### BACKGROUND OF THE INVENTION

1. Field of the Invention

This invention relates to apparatus and methods for coding the wavefront formed by a zoom lens and processing the resulting images so that the system is insensitive to focus related aberrations, and depth of field and depth of focus are extended.

2. Description of the Prior Art

Zoom lens designs are based on the property that the power of an optical system consisting of at least two lens groups can be varied by changing the distance between the groups. The lens capabilities depend on the number of moving groups in the system. This is discussed by W. J. Smith in “Modern Optical Engineering” McGraw-Hill, 1990. In any zoom system, at least two lens groups must be moved with respect to each other in order to have a variable focal length system and a fixed image plane position.

The complexity of a lens mechanical mount, or cam, is determined by the number of moving groups within the zoom lens. An example of a simple cam with two grooves is shown in W. J. Smith, FIG. 9.31, p. 276.

More moving optical groups may be required if other optical system characteristics are needed such as quality imaging over a range of object distances with large zoom power, or if the entrance and exit pupil locations need to be fixed. More elements within each group are often required to compensate for aberrations, as is the case with any traditional lens system.

Most of the modern miniature zoom lenses are composed of two groups of negative and positive powers. Such systems then have small size but a long back focal length, which is a serious drawback. For minimization purposes, these lens groups are further divided into subgroups that move independently to extend the zooming range and to attempt to minimize the overall size of the system. See, for example, U.S. Pat. No. 4,936,661 granted to E. I. Betensky, et al Jun. 26, 1990, U.S. Pat. No. 5,270,861 and U.S. Pat. No. 5,270,867 both granted to L. R. Estelle on Dec. 14, 1993. A two-element zoom system with negative and positive plastic elements is discussed in U.S. Pat. No. 5,473,473 granted to L. R. Estelle on Dec. 5 1995. This is a 35 mm format lens with a speed of F/11 in the wide-angle position.

U.S. Pat. No. 5,748,371 teaches that modifying the optics of the system such that the image is invariant with misfocus can increase the depth of field of an incoherent optical imaging system. This image is not clear and sharp, but with signal processing, an image can be formed that is clear with good resolution. This technique involves the modification of the optics to “code” the wavefront, and signal processing to “decode” the detected image. This process can be called Wavefront Coding.

Wavefront Coding is a relatively new technique that is used to reduce the effects of misfocus in sampled imaging systems through the use of aspheric optics and image processing of the resulting images. Wavefront Coding also can be used to control general misfocus-like aberrations allowing the simplified design of digital imaging systems.

A conventional general imaging system 100 is shown in FIG. 1 (Prior Art). Object 102 is imaged by conventional imaging optics 104 onto image detector 108. This image is formed without further image processing. All aberrations must be corrected by selection of the lens materials, shape, and spacing between the elements. For fast or wide angle systems, this typically requires that several lens elements be used. Final image 112 is formed from the image detected by detector 108 (or may actually be the image detected, in the case of film, for example).

The layout of a conventional Wavefront Coded imaging system is shown in FIG. 2 (Prior Art). The Imaging Optics 204 are modified such that the wavefront is coded to make the image that falls on intermediate image detector 208 relatively insensitive or invariant to misfocus and misfocus-type aberrations. Image processing 210 is used to form the final image 212.

Imaging Optics 204 collects light reflected or transmitted from Object 202. Wavefront Coding Optics 206 modifies the phase of the light before detector 208. Wavefront Coding Optics are generalized aspheric surfaces. Detector 208 can be analog film which is later sampled, CCD or CMOS detectors, etc. The image from detector 208 is spatially blurred because of Wavefront Coding Optics 206. The image also is very insensitive to misfocus aberrations. Image processing 210 is used to remove the spatial blur resulting in a final image that is insensitive to misfocus aberrations. These misfocus aberrations can be due to the Object 202 being beyond the depth of field of the Imaging Optics 204, the detector 208 being beyond the depth of focus of the Imaging Optics 204, or from Imaging Optics 204 having some combination of the misfocus aberrations of spherical aberration, chromatic aberration, Petzval curvature, astigmatism, fabrication or assembly related misfocus aberrations, or temperature related misfocus.

What prior art does not teach is that a zoom lens can be made to be small, light, and compact by the use of Wavefront Coding. There is a need in the art for small, compact, and inexpensive zoom lenses.

### SUMMARY OF THE INVENTION

An object of the present invention is to provide for a fast zoom lens with the minimum number of lens elements that provides high quality images over a large field of view, and at different zoom positions. This invention enables simple and inexpensive fast wide-angle zoom lens with as few as two plastic elements. The cost of the imaging system is directly reduced by minimizing the number of elements in the optical system and/or indirectly by reducing fabrication and assembly tolerances required to produce the system.

The number of elements in the optical system is reduced by coding the wavefront that is produced by the imaging system such that the imaging system is invariant to aberrations that are related to misfocus. Such aberrations include chromatic aberration, spherical aberration, curvature of field, astigmatism, fabrication and assembly related misfocus, and temperature related misfocus. Image processing is used to decode the formed images and produce the final images.

Normally, such aberrations can not easily be accommodated in a simple zoom lens with very few lenses because of the large number of aberrations that need to be controlled and because of the changing parameters in the zoom imaging system. This invention shows how a high quality image can be formed with a zoom system with the theoretically minimum number of lenses.

An extended depth of field zoom lens system according to the present invention includes a detector, a lens system between the object to be imaged and the detector comprising at least two lenses, and Wavefront Coding optics between the object and the detector. The Wavefront Coding optics are constructed and arranged to alter the optical transfer function of the zoom lens system in such a way that the altered optical transfer function is substantially less sensitive to focus related aberrations than was the unaltered optical transfer function. The Wavefront Coding optics affects the alteration to the optical transfer function substantially by affecting the phase of light transmitted by the optics. A post processing element processes the image captured by the detector, by reversing the alteration of the optical transfer function accomplished by the optics.

The Wavefront Coding optics may be integrally formed with at least one of the lenses. In one embodiment, information regarding the location of the lenses in the lens system are provided to the post processing element. The processing applied by the post processing element is adjusted according to the lens information. More generally, information regarding the point spread function (PSF) of the lens system is provided to the post processing element and processing is modified according to the information.

In another embodiment, the lens system comprises at least three lenses, and the lens system is constructed and arranged to have a constant F/#. In this embodiment, it is not necessary to provide the processing element with any information regarding PSF or lens position.

As a feature, the detector may be a charge coupled device (CCD). At least one of the lenses in the lens system may be made of optical plastic. The lens system may comprise two lenses in a positive/positive lens element configuration.

The Wavefront Coding Optics may implement a separable cubic phase function, a non-separable cubic phase function, or a cubic related phase function.

### BRIEF DESCRIPTION OF THE DRAWINGS

FIG. 1 (prior art) shows a conventional general imaging system.

FIG. 2 (prior art) shows a conventional Wavefront Coding imaging system.

FIGS. 3A and 3B show a zoom imaging system according to the present invention, with two lens elements. One or more of the lenses performs Wavefront Coding.

FIGS. 4A and 4B show a zoom imaging system according to the present invention, with three lens elements such that the working F/# is constant. One or more of the lenses performs Wavefront Coding.

FIG. 5 shows a simple cubic phase function that produces an extended depth of field.

FIGS. 6A and 6B show ray traces for a two-element zoom lens according to the present invention.

FIGS. 7A-7D show MTFs for an imaging system with no Wavefront Coding at wide angle and telephoto settings.

FIGS. 8A-8D show through-focus MTFs at 10 lp/mm for a two element zoom system without Wavefront Coding for wide angle and telephoto settings.

FIGS. 9A-9D show MTFs for an imaging system with Wavefront Coding according to the present invention at wide angle and telephoto settings, before processing.

FIGS. 10A-10D show through-focus MTFs at 10 lp/mm for a two element zoom system with Wavefront Coding for wide angle and telephoto settings, before processing.

FIGS. 11A-11D show the wide angle and telephoto MTFs of FIGS. 8A-8D after signal processing.

FIG. 12A shows a spatial domain linear filter according to the present invention for processing the intermediate image in order to produce the final image.

FIG. 12B shows the transfer function of the linear filter of FIG. 12A.

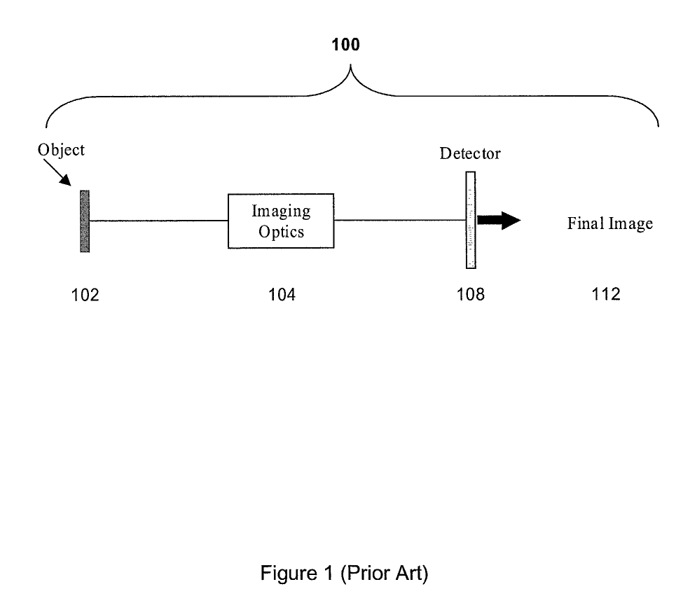

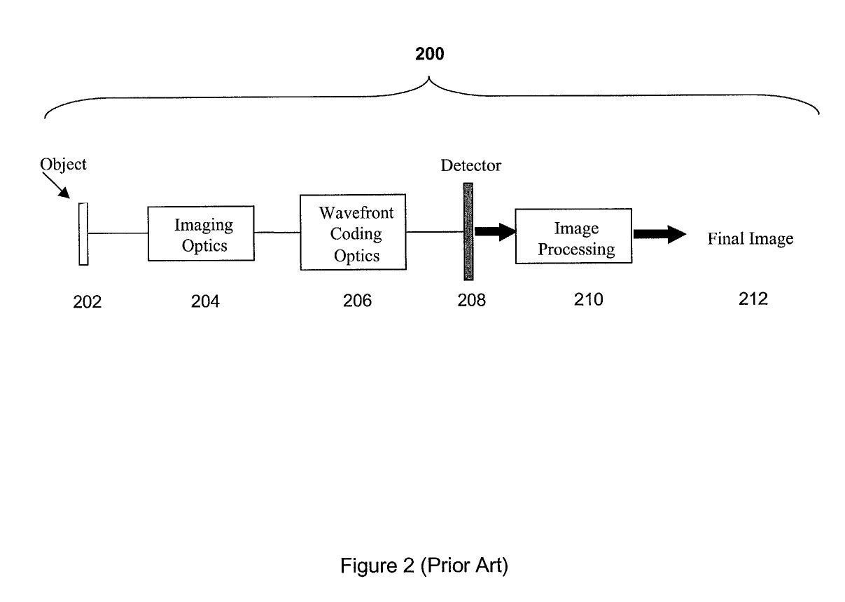

### DETAILED DESCRIPTION OF THE PREFERRED EMBODIMENTS

By coding the image forming wavefront and performing image processing on the resulting images zoom lenses can be designed that are very fast (small F/#) with a minimum number of optical elements. These zoom lenses can also have a very wide field of view and the equivalent of a flat image plane. By coding the wavefront and using image processing the zoom system can have a greatly increased the depth of field and depth of focus as well as reduced system sensitivity to misfocus aberrations. The extension of the depth of focus also means that the zoom lens can be made insensitive to temperature changes. In a similar fashion, manufacturing and assembly tolerances can be relaxed so that the accuracy with which the optics and detector array must be placed is reduced.

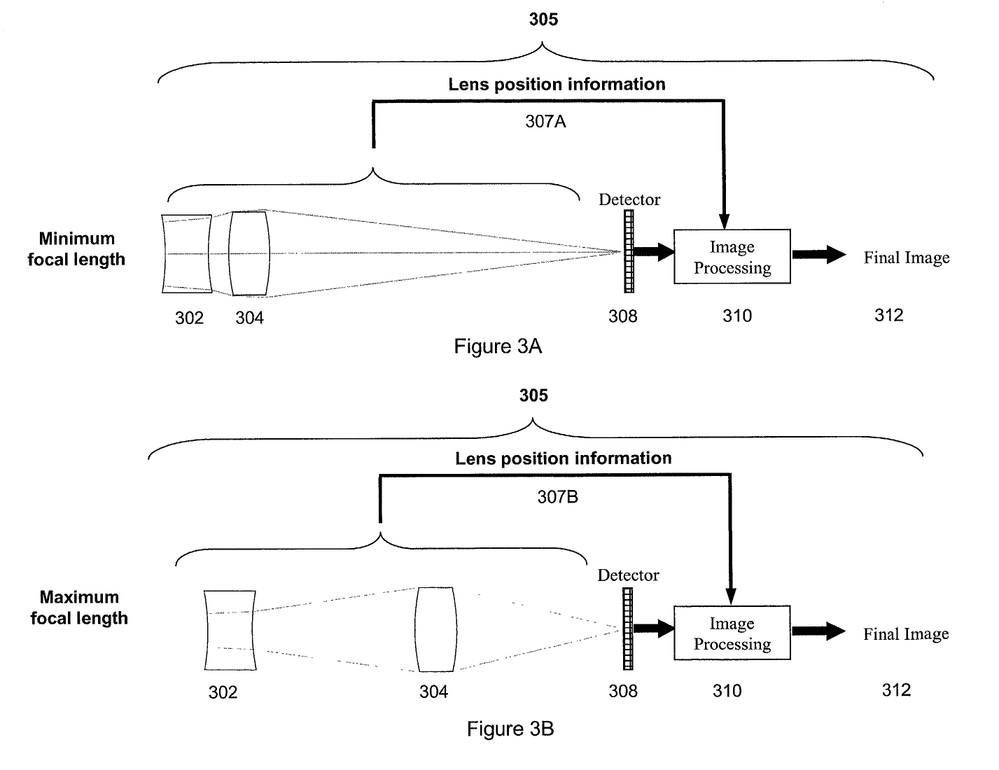

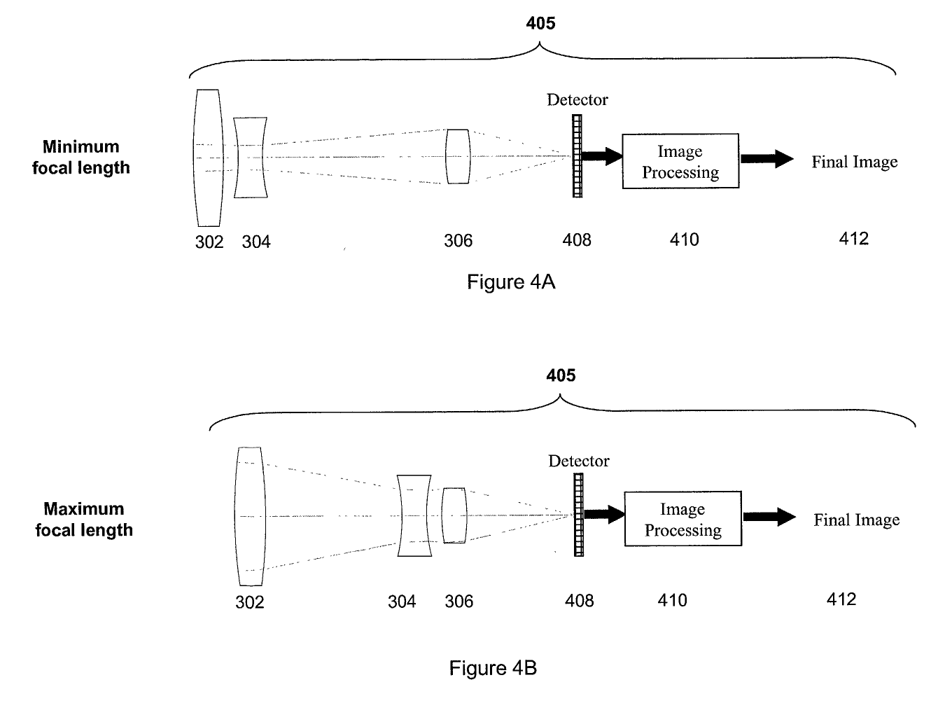

There are two primary forms of zoom lens systems that use Wavefront Coding. The first form, shown in FIG. 3, uses as few as two lens elements. By changing the distance between the two lens elements the value of the system focal length is varied, but the working F/# of the system also changes. With the working F/# varying, the PSFs and MTFs of the system also vary. This requires that the image processing have access to lens position information so that the configuration of the optics is known to the image processing. Image processing optimized for groups of working F/#s, or equivalently for regions of system focal lengths, can then automatically be selected and used to process the resulting images as a function of zoom system configuration. The second zoom system form, shown in FIG. 4, uses a minimum of three lens elements, and can maintain a constant working F/# with system focal length. When the working F/# is held constant the PSFs and MTFs are also constant with zoom configuration. With PSFs and MTFs that are not a function of the zoom system configuration the digital processing does not need information on the position of the optics.

FIG. 3A shows a zoom imaging system 305 according to the present invention with two lens elements 302 and 304, at least one of which has a modified surface to code the wavefront. Lens position information 307A is needed to select the appropriate image processing 310 such that the final image 312 is formed. FIG. 3B shows the same zoom imaging system 305 in a different zoom position, which requires different lens position information 307B to be sent to the image processing 310 to form the final image 312. The reason image processing block 310 requires lens position information 307 in a two lens system such as 305 is illustrated by the ray angles near the detector 308 in FIG. 3A compared to the ray angles near the detector of FIG. 3B. The rays enter the detector at very different angles for the two lens configurations. When the ray angles are different for the two configurations the working F/#s, PSFs and MTFs for the two configurations are also different. Thus, the processing applied by image processing block 310 must account for these differences.

FIGS. 4A and 4B show a zoom imaging system 405 according to the present invention with three lens elements 402, 404, and 406 which are constructed and arranged such that the working F/# is constant as the system focal length is varied. One or more of the lens elements 402, 404, and 406 have modified optics to perform Wavefront Coding. Image processing block 410 of system 405 does not require lens position information because the image processing applied by block 410 does not depend on knowledge of the configuration of lens elements 402, 404, and 406 to obtain the final image. This is illustrated by the ray angles to the right of element 406 in FIG. 4A compared to the ray angles FIG. 4B. The rays enter the detector at the same angles independent of the system focal length. Thus the working F/#, PSFs, and MTFs are not a function of the focal length of the system and the image processing 410 does not need any knowledge of the configuration of the optics.

To make such zoom lenses, one or more of the optical elements 302 and 304 of FIG. 3, and 402, 404, and 406 of FIG. 4 must encode the wavefront so that the resulting images are insensitive to focus related aberrations. This preferably done by applying special phase variation structures to one or more of these optical elements. For example, the thickness of one or more of the lenses can be varied in such a manner as to apply the desired wavefront (phase) modifications. Other methods of modifying the wavefront that are useful for these systems include use of optical materials that have a spatially varying index of refraction and/or thickness, use of spatial light modulators, use of holograms, or by use of micro mirror devices.

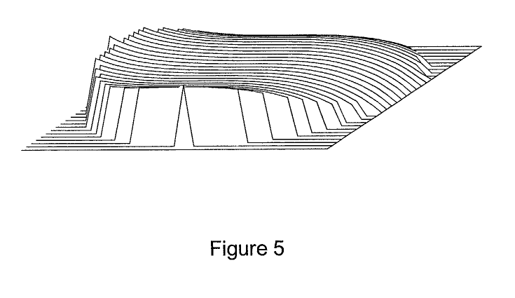

FIG. 5 shows an example of modifications made to a traditional lens 302, 304, 402, 404, or 406 having thickness variations which encode the wavefront of light passing through the lens. These lens modifications apply a wavefront phase function that produces an extended depth of field in the resulting images. For example, the phase function applied may be a conventional simple cubic phase function that is mathematically described as:

separable-cubic-phase(x,y)=K[x³+y³ ]

where K is a constant.

Alternatively, a non-separable conventional Wavefront Coding phase function, in normalized coordinates, is:

non-separable-cubic-phase(p, θ)=p³ cos(3 θ)

0≦p≦1, 0≦θ≦2 pi

Other alternative conventional Wavefront Coding phase functions are described as:

cubic-related-forms(x,y)=a[sign(x)|x|^{b}+sign(y)|y|^{b}]

|x|≦1, |y|≦1

where sign(x)=+1 for x≧0, sign(x)=−1 otherwise. For b an odd integer these related forms trace out “cubic like” profiles of increasing slopes near the end of the aperture. For b with values between the odd integers, the related forms trace out other “cubic like” profiles that lie between the ones generated when b is an odd integer.

The phase functions given above are useful for controlling misfocus and for minimizing optical power in high spatial frequencies. Minimizing the optical power at high spatial frequencies is often called antialiasing. When using a digital detector such as a CCD or CMOS device to capture an image, optical power that is beyond the spatial frequency limit of the detector masquerades or “aliases” as low spatial frequency power. For example, say that the normalized spatial frequency limit of a digital detector is 0.5. If the in-focus MTF from the conventional system with no Wavefront Coding can produce a considerable amount of optical power beyond this spatial frequency limit then aliasing artifacts could greatly degrade the resulting images. By adding misfocus to the system without Wavefront Coding the amount of high spatial frequency optical power can be decreased, and aliasing reduced, as is well known. When using Wavefront Coding the amount of optical power that can be aliased can also decrease. In comparison to using misfocus in systems without Wavefront Coding to reduce aliasing, the amount of aliasing in a wavefront coded system does not increase with a change of focus.

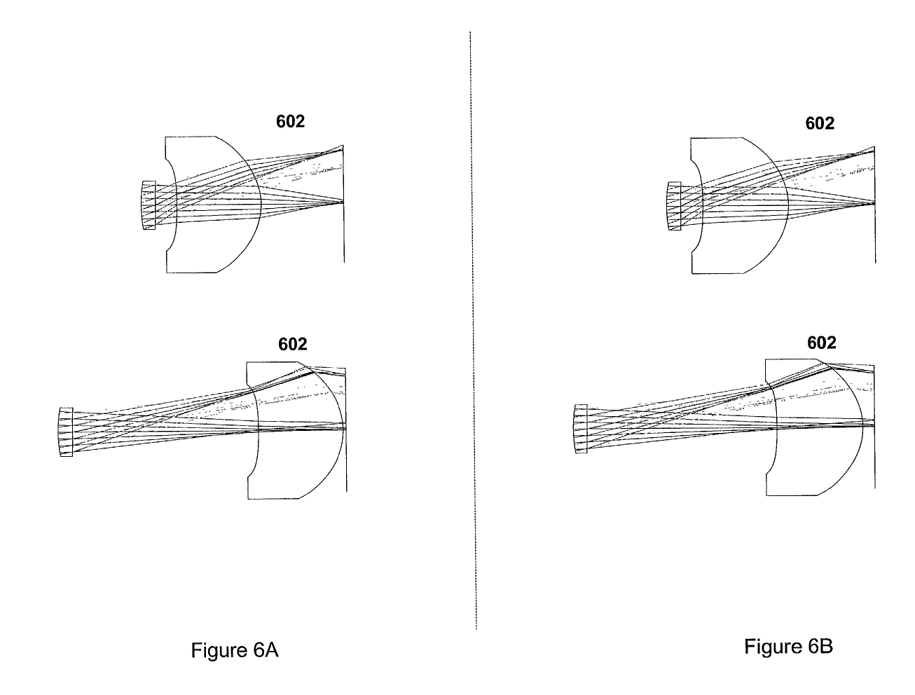

FIGS. 6A and 6B show ray traces for a two-element zoom lens 602, with Wavefront Coding according to the present invention, in two configurations. Lens system 602 is the type of zoom lens used in FIG. 3. FIG. 6A shows ray traces for the wide angle configuration (top plot) and the telephoto configuration (bottom plot) for standard imaging of objects at infinity. FIG. 6B shows ray traces for the wide angle configuration (top plot) and the telephoto configuration (bottom plot) in a macro mode for objects at 200 mm.

A two element zoom lens system has a total of three combinations of lens elements that can be used. These combinations are:

1. Positive/positive

2. Positive/negative

3. Negative/positive

Traditional two element zoom systems nearly always employ either the positive/negative or negative/positive lens element configurations. This is because the use of positive and negative lens element combinations allows the lens designer to minimize the aberration of petzval curvature that otherwise would drastically limit the field of view of the traditional zoom system. Designs that employ the positive/positive lens element combination can have the shortest overall length, compared to designs that use negative lens elements, but also implicitly have the largest amount of petzval curvature. In traditional designs this petzval curvature is large enough to preclude the practical use of the positive/positive arrangement for traditional two element zoom systems.

In many zoom lens designs minimum overall length and wide field of view are both demanded. By using Wavefront Coding methods the two element zoom lens design can use the positive/positive lens element combination in order to minimize the overall length of the system while correcting the aberration of petzval curvature and other focus related aberrations by coding the wavefront and image processing the resulting images. Use of Wavefront Coding thus enables the design of a shorter zoom lens then is possible with traditional design methods. FIG. 6 shows a positive/positive zoom system 602.

The preferred embodiment of the positive/positive two-element zoom system 602 is specified below. This zoom system has been designed to image in a standard mode with objects at infinity, and in a macro mode with objects near 200 mm. The zoom system will also work well with objects at intermediate positions. The full field of view of lens system 602 continuously varies from about 23°0 to 52°. This system is designed to be used with a digital detector with 5.6 micron square pixels and a Bayer color filter array. This detector also has lenslet array. In order to ensure maximum light collection by the lenslet array the maximum chief ray angles for each of these configurations have been designed to under 11°. Those skilled in the art of optical design will realize that this or similar lens systems can be used with a variety of other digital detector formats as well. All dimensions below are given in mm and indices of refraction and dispersions (V) are for the d line of the spectrum. Surface number 1 is the front of the first lens element.

The mechanical layout of preferred embodiment is:

| SURFACE | RADIUS | THICKNESS | INDEX | V |
|---|---|---|---|---|
| 1 | ASPHERE | 0.482 | 1.530 | 55.8 |
| 2 | ASPHERE | (A) | | |
| 3 | ASPHERE | 2.855 | 1.530 | 55.8 |
| 4 | ASPHERE | (B) | | |
| Image | | | | |

Surface #2 is the stop. Surface #2 also contains the Wavefront Coding surface. The thickness of surfaces 2 and 4 vary with zoom configuration. See below. The lens material is the optical plastic zeonex.

The rotationally symmetric aspheric surface height as a function of spatial position, or radius, is given

$$Z = \frac{C {r}^{2}}{1 + s q r t \{ 1 - ( K + 1 ) {C}^{2} {r}^{2} \}} + D {r}^{4} + E {r}^{6} + F {r}^{8} + G {r}^{10} + H {r}^{12}$$

The constants that define the rotationally symmetric surfaces are given as:

| | | | |
|---|---|---|---|
| Surface 1 | C = 0.233386 | D = −0.031277 | F = −0.128988 |
| | K = 3.656 | E = 0.080978 | G = 0.087080 |
| | | | H = −0.010498 |
| Surface 2 | C = 0.002507 | D = 0.029598 | F = 0.103280 |
| | K = 0.0 | E = −0.089061 | G = 0.0 |
| | | | H = 0.0 |
| Surface 3 | C = −0.085283 | D = −0.012930 | F = 0.011175 |
| | K = 53.030 | E = −0.014721 | G = 0.004873 |
| | | | H = 5.699E−04 |
| Surface 4 | C = −0.459841 | D = 0.006828 | F = −2.809E−04 |
| | K = −0.344 | E = −3.565E−04 | G = 7.026E−05 |
| | | | H = −5.739E−06 |

Surface 2 contains the stop as well as the Wavefront Coding surface. The Wavefront Coding surface is used in addition to the rotationally symmetric surface 2 defined above. The Wavefront Coding surface form is defined as:

$$\begin{matrix}S ( x , y ) = {β}_{1} [ sign ( \underline{x} ) \vert \underline{x} {\vert}^{α1} + sign ( \underline{y} ) \vert \underline{x} {\vert}^{α1} ] + \\ {β}_{2} [ sign ( \underline{x} ) \vert \underline{x} {\vert}^{α2} + sign ( \underline{y} ) \vert \underline{y} {\vert}^{α2} ]\end{matrix}$$

where x=x/|xₘₐₓ |, y=y/|yₘₐₓ |

and where sign (x)=+1 for x≧0, and sign (x)=−1 otherwise, The parameters β₁ and β₂ control the contribution of each term and α₁ and α₂ control the maximum slope of each term. The values of α and β are:

β₁=26.666, α₁=3.006

β₂=69.519, α₂=9.613

The distance between the two lenses (A) of system 602 is a function of the focal length the zoom system. The distance from the second lens to the image detector (B), also known as the back focal length, is a function of the focal length and object position. In the standard imaging mode, with the object at infinity, the system distances, lengths, and working F/#s are:

Standard imaging, object at infinity

| | Lens | Back focal | | |
|---|---|---|---|---|
| Focal | spacing | length | Overall | Working |
| Length | (A) | (B) | Length | F/# |
| 3.864 | 0.725 | 2.794 | 6.857 | 2.8 |
| 6.136 | 4.226 | 1.549 | 9.113 | 4.3 |
| 9.454 | 6.315 | 0.100 | 9.753 | 6.2 |

When used in macro mode the object position can be as close as 200 mm. Back focal length (B) varies with object distance. Lens spacing (A) is the same in standard and macro imaging. In the macro imaging mode, with the object at 200 mm, the system distances, lengths, and working F/#s are:

Macro imaging, object at 200 mm

| | Lens | Back focal | | |
|---|---|---|---|---|
| Focal | spacing | length | Overall | Working |
| Length | (A) | (B) | Length | F/# |
| 3.864 | 0.725 | 2.870 | 6.930 | 2.8 |
| 6.136 | 4.226 | 1.770 | 9.332 | 4.3 |
| 9.454 | 6.315 | 0.391 | 10.044 | 6.0 |

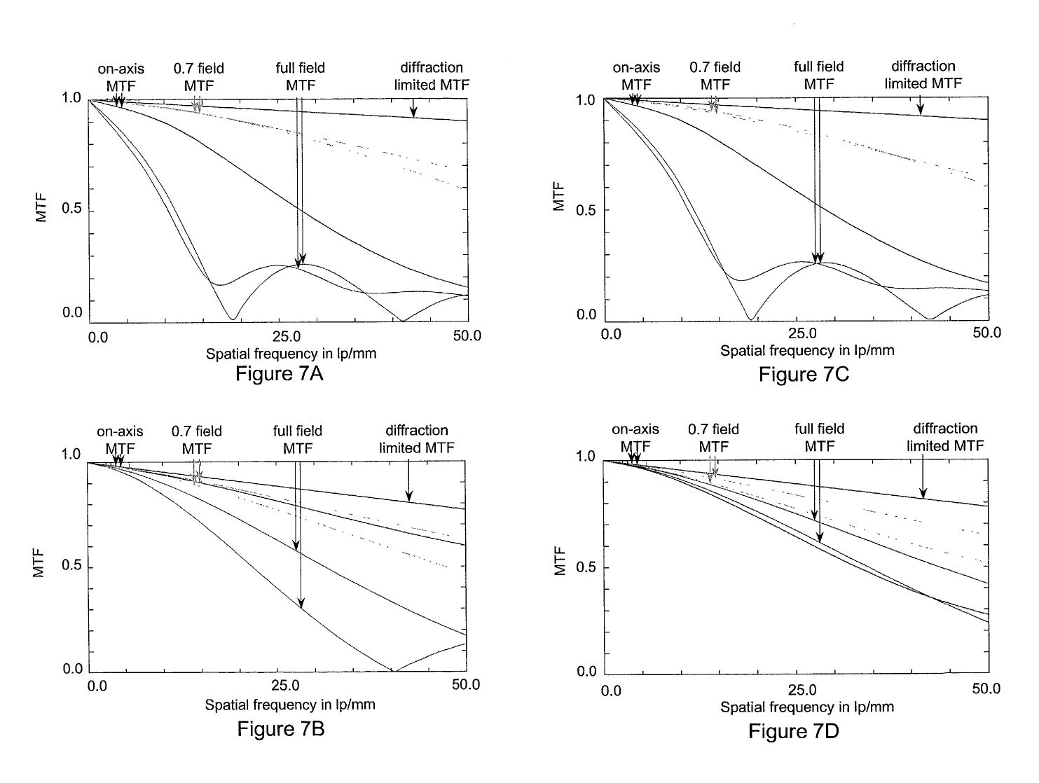

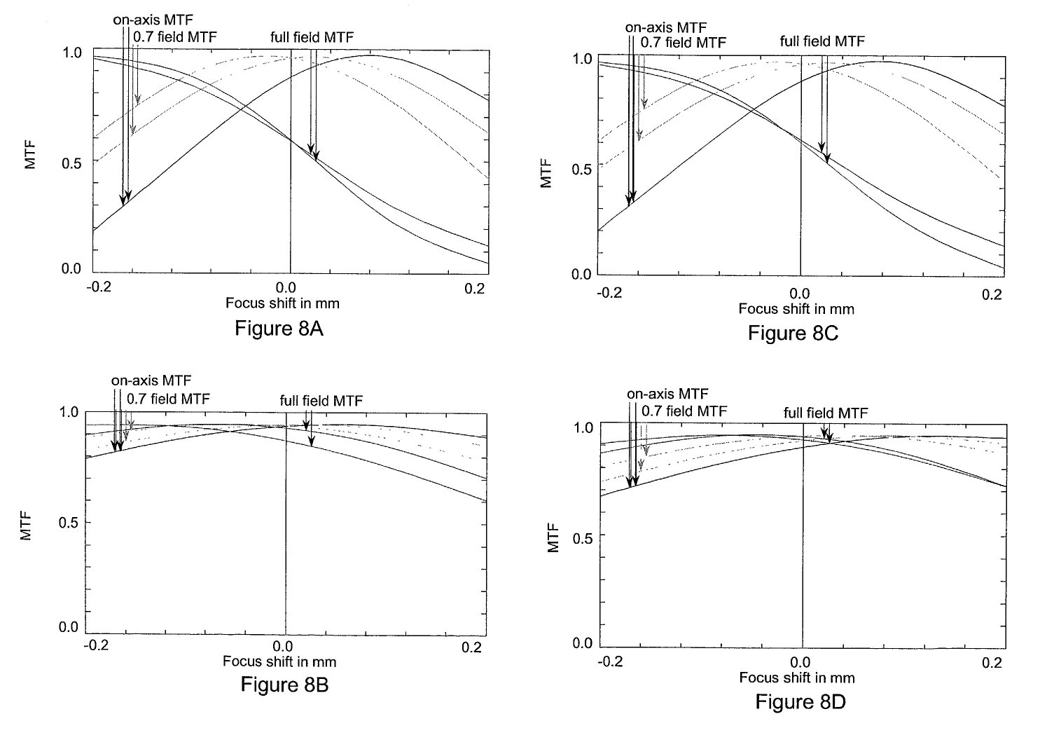

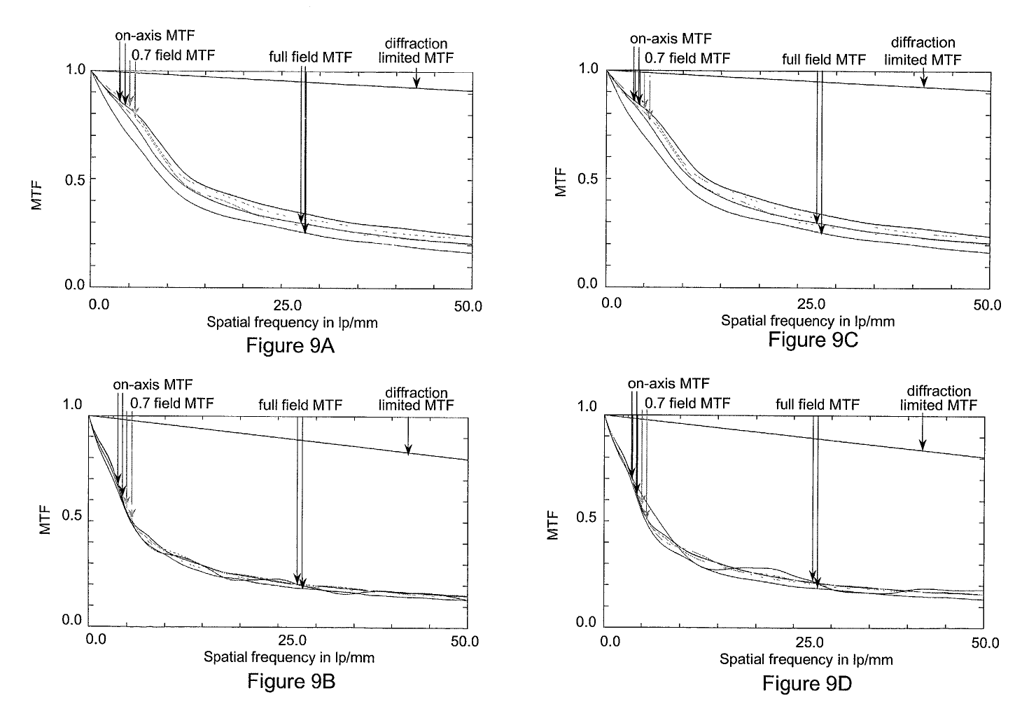

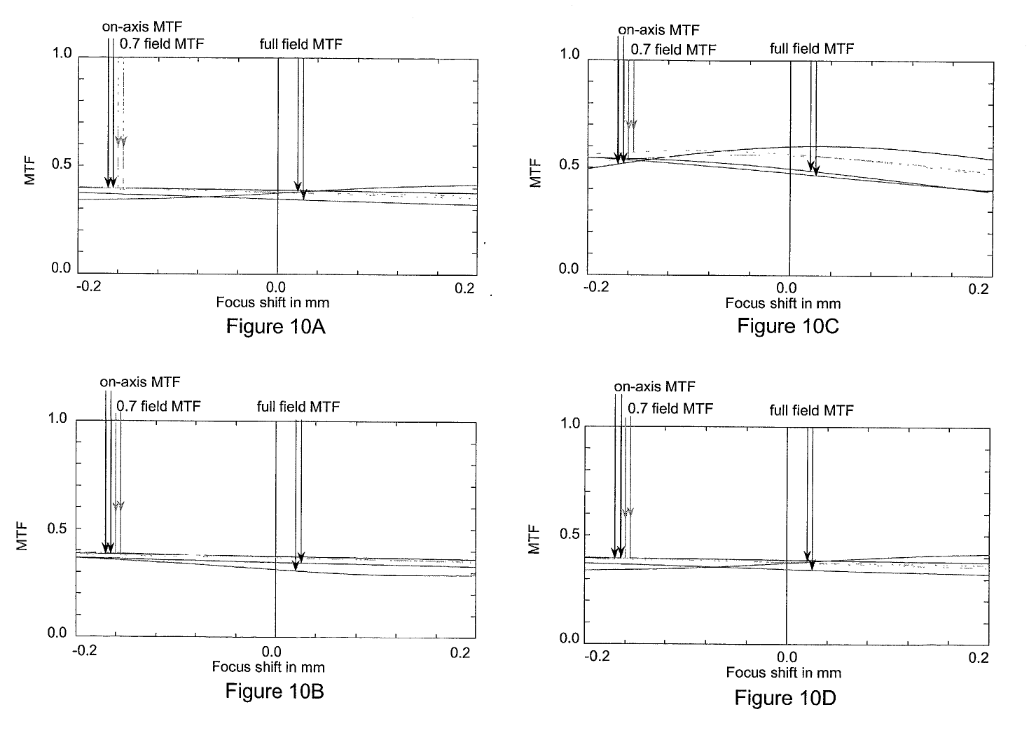

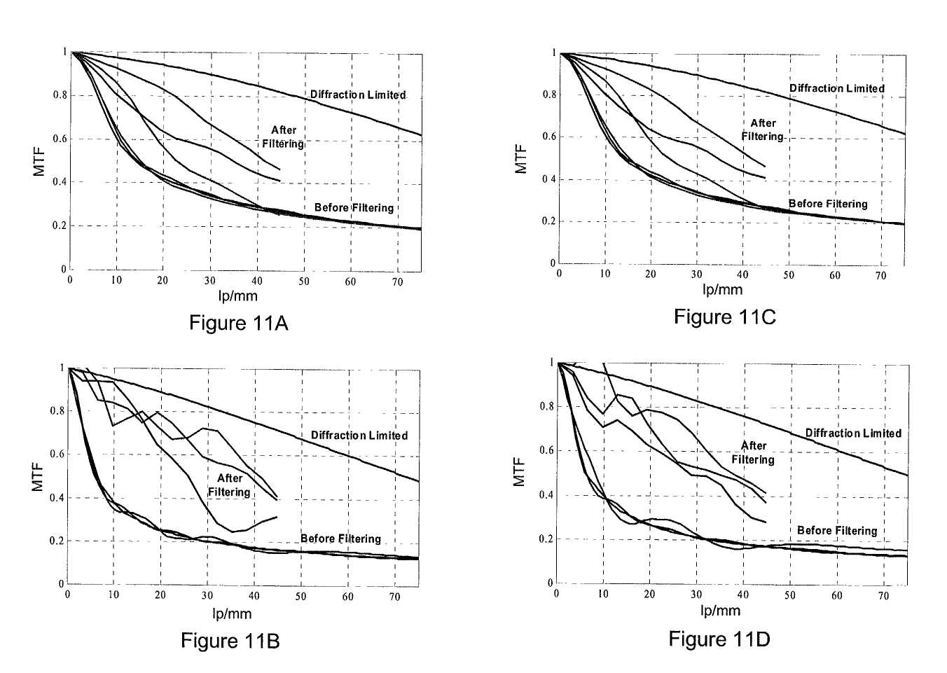

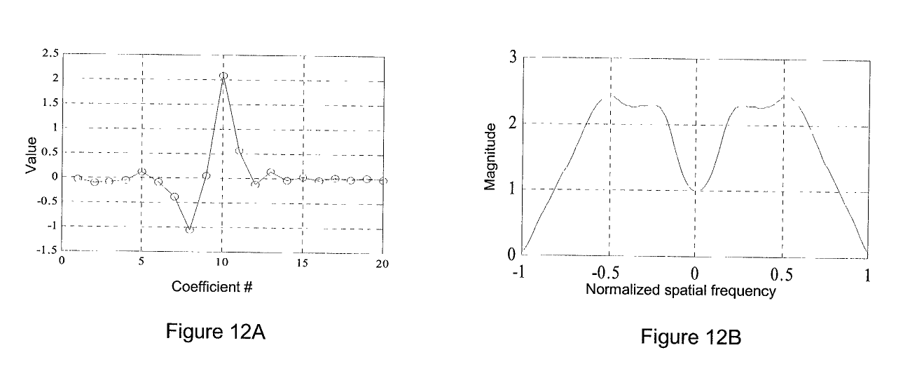

The performance of the wavefront coded zoom lens system 602, as specified above, is described and compared to a zoom system not using Wavefront Coding in FIGS. 7 through 12. FIGS. 7 and 8 describe the MTF characteristics of the zoom system without Wavefront Coding. FIGS. 9 and 10 describe the MTF performance of the zoom system with Wavefront Coding but before image processing 410. FIG. 11 describes the MTF performance of the zoom system 602 after image processing 410. FIG. 12 describes the digital filters used in image processing 410.

The MTFs of the zoom system without Wavefront Coding are described in FIG. 7. The zoom system without Wavefront Coding is as described above but with the Wavefront Coding parameters β₁=β₂=0. FIGS. 7A and 7B describe the system in standard imaging mode with the object at infinity at the shortest focal length or widest imaging angle and at the longest focal length or narrowest imaging angle or telephoto respectively. FIGS. 7C and 7D are similar to FIGS. 7A and 7B with the system in macro imaging mode and the object being at 200 mm. FIG. 7C describes wide angle imaging while 7D described telephoto imaging. The Wavefront Coding design method consists of minimizing, through traditional design methods, the non-focus related aberrations, such as coma, lateral color, and distortion. Focus related aberrations are controlled both through traditional design techniques and through Wavefront Coding via the optics and image processing.

With the positive/positive lens element configuration of zoom system 602 the largest monochromatic aberrations are related to field curvature. The effects of field curvature are clearly seen in the off-axis MTFs of the FIGS. 7A-7C. In these Figures the full-field MTFs have drastically lower responses then the on-axis MTFs. The full-field MTFs also have zeros caused by misfocus as a function of field angle (or field curvature) within the spatial frequency limit of the Bayer detector of 44 lp/mm. This two element zoom system without Wavefront Coding would image well only at small field angles or with a very small sized detector.

FIG. 8 describes the MTFs of the zoom system without Wavefront Coding at a spatial frequency of 10 lp/mm over a −0.2 mm to +0.2 mm deviation from the best focused image plane, or the through focus MTFs at 10 lp/mm. These curves again clearly show the limiting nature of field curvature on the zoom system without Wavefront Coding. FIGS. 8A-8D are arranged as in FIG. 7 with FIGS. 8A and 8B describing imaging with the object at infinity at wide angle and telephoto positions respectively. FIGS. 8C and 8D describe similar in a macro mode with the object at 200 mm. In FIGS. 8A and 8C the peak of the full field MTF is seen to be around −0.2 mm from best focus while the peak of the on-axis MTF is about +0.1 mm from best focus. Best focus has been adjusted to balance the effects field curvature so that the 0.7 field MTF is at best focus. FIGS. 8B and 8D show similar but less dramatic effects of field curvature due to the smaller field angles of the telephoto configurations. From FIG. 8 there is no one focus position with the system without Wavefront Coding where all field angles are well focused.

FIG. 9 shows the MTFs from the two element zoom system 602 with Wavefront Coding, but before image processing 410, according to the present invention. FIGS. 9A and 9B represent MTFs with the object at infinity at wide angle and telephoto configurations respectively. FIGS. 9C and 9D represent the MTFs with the object at 200 mm at wide angle and telephoto configurations respectively. From the MTFs of FIGS. 9A-9D notice that there is very little change in MTFs with field angle. All MTFs for each configuration are essentially identical, especially compared to the MTFs from the system without Wavefront Coding shown in FIG. 7. Notice also that the MTFs of FIG. 9 do not match the diffraction limited MTFs. The wavefront coded MTFs are lower than the diffraction limited MTFs but higher than the off-axis MTFs from the system without Wavefront Coding in FIG. 7. Image processing 410 is used to essentially transform the MTFs shown in FIG. 9 to any desired MTF. Typically image processing 410 is used to form MTFs that lay between the unprocessed wavefront coded MTFs and the diffraction limited MTFs.

FIGS. 10A-10D describes the through focus MTFs at 10 lp/mm of the zoom system 602 with Wavefront Coding, but without image processing 410, according to the present invention. The arrangement of FIGS. 10A-10D is similar to that of FIGS. 9A-9D. Notice that the response of the through focus MTFs are much more independent of focus shift than the system without Wavefront Coding shown in FIG. 8. From FIG. 10A there is a large region, at least +/−0.2 mm, where the image plane can be positioned and still have essentially identical performance. By not having separated peaks of the through focus MTFs as a function of field angle, the Wavefront Coding MTFs are seen to not suffer from effects of field curvature. By also having a large region over which the image plane can be positioned and still image clearly, the wavefront coded system is seen to also have a large depth of focus. The depth of focus is seen to be the least for FIG. 10C as the response curves as a function of field angle vary the most for this configuration (wide angle, object at 200 mm).

FIGS. 11A-11D describes the MTFs for zoom system 602 with Wavefront Coding and with image processing 410 according to the present invention. FIGS. 11A and 11B describe the MTFs with the object at infinity imaging in wide angle and telephoto configurations respectively. FIGS. 11C and 11D describe the MTFs when the object is at 200 mm and in wide angle and telephoto configurations respectively. The MTFs of FIG. 11 include the MTFs due to the optics and the MTFs due to the 5.6 micron square pixel Bayer detector. The diffraction limited MTFs shown in FIG. 11 are those of FIG. 9 with the addition of the detector MTFs. Each figure shows the diffraction limited MTF, the MTFs before image processing 410, and the MTFs after image processing 410. The MTFs after image processing, or filtering, extend to the spatial frequency limit of the digital detector or 44 lp/mm. The MTFs after filtering for FIGS. 11A-11D lay between the MTFs before filtering and the diffraction limited MTFs. The corresponding PSFs after filtering, not shown, are spatially very compact. Only one digital filter is applied to each configuration of the zoom system. For example when imaging with a wide angle and object at infinity (FIG. 11A) a single digital filter is applied to all images. When the optics are changed to image in telephoto mode with the object at infinity (FIG. 11B) another digital filter is applied to all images resulting from this configuration.

FIG. 12 describes one dimension of the two dimensional digital filter used to form the MTFs after filtering in FIG. 11. The two dimensional filter is implemented as a rectangularly separable digital filter. FIG. 12A describes one dimension of the rectangularly separable filter. FIG. 12B shows the transfer function of the spatial domain filter of FIG. 12A.

For zoom system 602, image processing 410 uses the digital filter from FIG. 12A in order to form the final images 412. Computationally efficient rectangularly separable digital filtering is preferred for implementations where the total number of multiply and additions must be minimized. General two dimensional linear filtering can also be used when maximum processing flexibility is needed. The operation of rectangularly separable filtering is to first filter each row (or column) independently with a one dimensional row (or column) filter. The filtered rows (or columns) form an intermediate image. Columns (or rows) of the intermediate image are then independently filtered with the column (or row) filter. This forms the final image.

The actual filter values as shown in FIGS. 12A and 12B are typically chosen to produce MTFs that match some desired MTF performance as well as produce PSFs that also match some desired spatial performance. MTF criteria after filtering typically include a minimum MTF values for groups of spatial frequencies. PSF criteria after filtering typically include a spatially compact shape with a maximum size for image artifacts. The actual digital filters can be calculated through least squares methods or through nonlinear computer optimization.

What is claimed is:

1. An improved zoom lens system for imaging an object comprising:
a detector;
a lens system between the object and the detector comprising at least two lenses;
Wavefront coding optics between the object and the detector;
said wavefront coding optics being constructed and arranged to alter the optical transfer function of the zoom lens system in such a way that the altered optical transfer function is substantially less sensitive to focus related aberrations than was the unaltered optical transfer function,
wherein the wavefront coding optics affects the alteration to the optical transfer function substantially by affecting the phase of light transmitted by the optics; and
a post processing element for processing the image captured by the detector by reversing the alteration of the optical transfer function accomplished by the optics.

2. The apparatus of claim 1, wherein the Wavefront Coding optics are integrally formed with at least one of the lenses.

3. The apparatus of claim 1, further comprising means for providing the post processing element with lens information regarding the location of the lenses in the lens system and means for modifying the post processing element according to the lens information.

4. The apparatus of claim 1, further comprising means for providing the post processing element with information regarding the point spread function (PSF) of the lens system and means for modifying the post processing element according to the information.

5. The apparatus of claim 1 wherein the lens system comprises at least three lenses, and wherein the lens system is constructed and arranged to have a constant F/#.

6. The apparatus of claim 1 wherein the detector is a charge coupled device (CCD).

7. The apparatus of claim 1 wherein at least one of the lenses in the lens system is made of optical plastic.

8. The apparatus of claim 7 wherein all of the lenses in the lens system are made of optical plastic.

9. The apparatus of claim 1 wherein the lens system comprises two lenses in a positive/positive lens element configuration.

10. The apparatus of claim 1 wherein the Wavefront Coding Optics implements a separable cubic phase function.

11. The apparatus of claim 1 wherein the Wavefront Coding Optics implements a non-separable cubic phase function.

12. The apparatus of claim 1 wherein the Wavefront Coding Optics implements a cubic related phase function of the form:
cubic-related-forms(x,y)=a[sign(x)|x|^{b}+sign(y)|y|^{b}]

|x|≦1, |y|≦1
where sign(x)=+1 for x≧0, sign(x)=−1 otherwise.

13. The method for reducing focus related aberrations in images formed by a zoom lens system comprising the steps of:
modifying the wavefront of transmitted light between the object to be imaged and a detector for capturing the image;
the wavefront modification selected to alter the optical transfer function of the zoom lens system in such a way that the altered optical transfer function is substantially less sensitive to focus related aberrations than the unaltered optical transfer function; and
post processing the image captured by the detector by reversing the alteration of the optical transfer function accomplished by the optics.

14. The method of claim 13 further comprising the steps of:
providing the post processing element with lens information regarding the location of the lenses in the zoom lens system; and
the step of modifying the post processing element according to the lens information.

15. The method of claim 13 further comprising the steps of:
providing the post processing element with information regarding the point spread function (PSF) of the zoom lens system; and
the step of modifying the post processing element according to the information.

16. The method of claim 13 wherein the wavefront modification step implements a separable cubic phase function.

17. The method of claim 13 wherein the wavefront modification step implements a non-separable cubic phase function.

18. The method of claim 13 wherein the wavefront modification step implements a cubic related phase function of the form:
cubic-related-forms(x,y)=a[sign(x)|x|^{b}+sign(y)|y|^{b}]

|x|≦1, |y|≦1
where sign(x)=+1 for x≧0 sign(x)=−1 otherwise.
